(19) United States
(12) Patent Application Publication
(10) Pub. No.: US 2024/0216859 A1
(43) Pub. Date: Jul. 4, 2024

(54) GAS RECOVERY SYSTEM

(71) Applicant: DENSO CORPORATION, Kariya-city (JP)

(72) Inventors: Takamasa ITO, Kariya-city (JP); Yuki WAKITA, Kariya-city (JP); Akihiro MIZUGUCHI, Kariya-city (JP)

(21) Appl. No.: 18/608,322

(22) Filed: Mar. 18, 2024

Related U.S. Application Data
(63) Continuation of application No. PCT/JP2022/030696, filed on Aug. 11, 2022.

(30) Foreign Application Priority Data
Sep. 24, 2021 (JP) 2021-155296

(51) Int. Cl. B01D 53/32; B01D 53/62

(52) U.S. Cl. CPC B01D 53/326; B01D 53/323; B01D 53/62; B01D 2257/504

(57) ABSTRACT

A gas recovery system, which recovers a recovery target gas from a mixed gas by an electrochemical reaction, includes a recovery unit into which the mixed gas is introduced and an electrochemical cell disposed in the recovery unit. The electrochemical cell includes a working electrode and a counter electrode. When a voltage is applied between the working electrode and the counter electrode, electrons are supplied from the counter electrode to the working electrode, and adsorbent of the working electrode bonds with the recovery target gas. The electrochemical cell is arranged so as to come in contact with the recovery target gas. The electrochemical cell has a wall surface forming part on a contact surface that comes in contact with the recovery target gas, and the wall surface forming part has a wall surface that faces in a flow direction of the recovery target gas.

### CROSS REFERENCE TO RELATED APPLICATION

The present application is a continuation application of International Patent Application No. PCT/JP2022/030696 filed on Aug. 11, 2022, which designated the U.S. and claims the benefit of priority from Japanese Patent Application No. 2021-155296 filed on Sep. 24, 2021. The entire disclosures of all of the above applications are incorporated herein by reference.

### TECHNICAL FIELD

The present disclosure relates to a gas recovery system that recovers a recovery target gas to be recovered from a mixed gas containing the recovery target gas.

### BACKGROUND

There has been known a gas recovery system that separates carbon dioxide, which is a recovery target gas to be recovered, from a mixed gas containing the carbon dioxide by an electrochemical reaction. In such a gas recovery system, a working electrode of an electrochemical cell is provided with a carbon dioxide adsorbent capable of adsorbing the carbon dioxide. The carbon dioxide adsorbent is an electroactive species, and adsorption and release of the carbon dioxide by the carbon dioxide adsorbent can be switched by changing the potential difference between the working electrode and a counter electrode.

### SUMMARY

The present disclosure describes a gas recovery system that recovers a recovery target gas from a mixed gas containing the recovery target gas by an electrochemical reaction. The gas recovery system includes a recovery unit into which the mixed gas is introduced, and an electrochemical cell disposed in the recovery unit and having a working electrode containing an adsorbent capable of adsorbing the recovery target gas and a counter electrode.

### BRIEF DESCRIPTION OF DRAWINGS

FIG. 1 is a conceptual diagram showing an overall configuration of a carbon dioxide recovery system according to a first embodiment.

FIG. 2 is a perspective view of a carbon dioxide recovery device according to the first embodiment.

FIG. 3 is a perspective view showing a state in which a plurality of electrochemical cells according to the first embodiment are stacked.

FIG. 4 is a perspective view of the electrochemical cell according to the first embodiment.

FIG. 5 is an enlarged view of a part V in FIG. 4.

FIG. 6 is a cross-sectional view taken along a line VI-VI in FIG. 5.

FIG. 7 is a perspective view of a carbon dioxide recovery apparatus according to a second embodiment.

FIG. 8 is a plan view of a contact surface of an electrochemical cell, when viewed in a cell stacking direction, according to the second embodiment.

FIG. 9 is a perspective view of a contact surface of an electrochemical cell according to the second embodiment.

FIG. 10 is a plan view of a contact surface of an electrochemical cell, when viewed in a cell stacking direction, according to a third embodiment.

FIG. 11 is a perspective view of a contact surface of an electrochemical cell according to a third embodiment.

FIG. 12 is a cross-sectional view of a contact surface of an electrochemical cell according to a fourth embodiment.

FIG. 13 is a perspective view of a contact surface of an electrochemical cell according to a fifth embodiment.

FIG. 14 is a plan view of a part of a contact surface of an electrochemical cell, when viewed in a cell stacking direction, according to a sixth embodiment.

FIG. 15 is a perspective view of a contact surface of an electrochemical cell according to a sixth embodiment.

### DETAILED DESCRIPTION

In a gas recovery system in which a mixed gas is caused to flow over a surface of a carbon dioxide adsorbent formed in a plate shape, the carbon dioxide contained in the mixed gas is adsorbed by the adsorbent. Therefore, if gas diffusion on the surface of the carbon dioxide adsorbent is not sufficient, the adsorption of the carbon dioxide into the carbon dioxide adsorbent is likely to be restricted, and the adsorption performance is likely to be reduced.

If the pressure loss of the mixed gas flowing on the surface of the carbon dioxide adsorbent is large, gas exchange before and after the adsorption of carbon dioxide is likely to be restricted, and thus there is a fear that the adsorption performance will be reduced.

The present disclosure provides a gas recovery system capable of improving adsorption performance of a recovery target gas.

According to an aspect of the present disclosure, a gas recovery system, which recovers a recovery target gas to be recovered from a mixed gas containing the recovery target gas by an electrochemical reaction, includes a recovery unit into which the mixed gas is introduced, and an electrochemical cell disposed in the recovery unit. The electrochemical cell includes a working electrode containing an adsorbent capable of adsorbing the recovery target gas and a counter electrode. When a voltage is applied between the working electrode and the counter electrode, electrons are supplied from the counter electrode to the working electrode, and the adsorbent bonds with the recovery target gas as the electrons are supplied. The electrochemical cell is disposed so as to come in contact with the recovery target gas. The electrochemical cell has a wall surface forming part on a contact surface that comes in contact with the recovery target gas, and the wall surface forming part has a wall surface that faces in a flow direction of the recovery target gas.

According to such a configuration, by providing the wall surface forming part having the wall surface facing in the flow direction of the recovery target gas, it is possible to form a vortex due to separation of a main flow of the recovery target gas by the wall surface forming part. As a result, diffusion of the recovery target gas can be promoted on the contact surface, which comes in contact with the recovery target gas, so the adsorption performance of the recovery target gas can be improved.

Hereinafter, a plurality of embodiments for implementing the present disclosure will be described with reference to the drawings. In the description of each embodiment, parts corresponding to the matters described in its preceding embodiment(s) will be denoted by the same reference numbers as in the preceding embodiment(s), and duplication of description will be omitted as appropriate. When only a part of a configuration is described in an embodiment, another preceding embodiment may be applied to the other parts of the configuration. The present disclosure is not limited to combinations that are explicitly described as being combinable in the description of an embodiment. As long as no problem is present, the embodiments may be partially combined with each other even if not explicitly described.

### First Embodiment

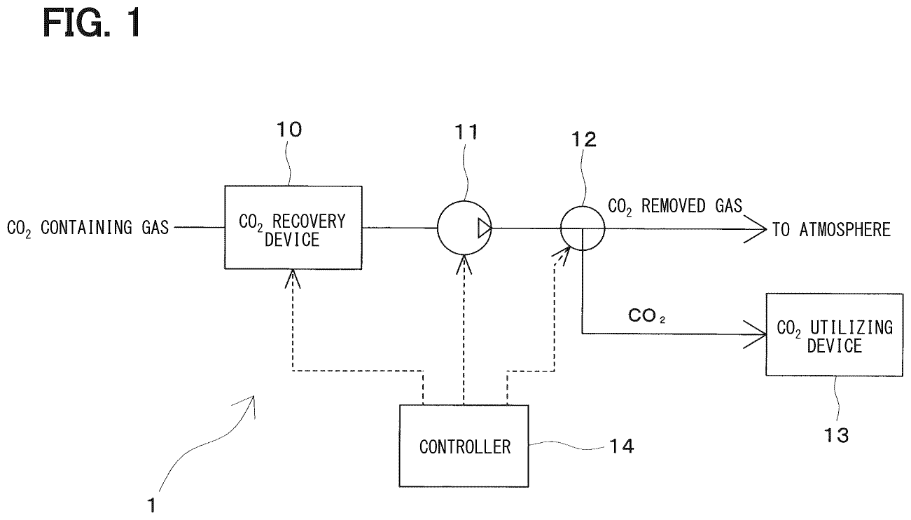

A first embodiment of the present disclosure will be described hereinafter with reference to the drawings. In the present embodiment, a gas recovery system of the present disclosure is applied to a carbon dioxide recovery system 1 that recovers carbon dioxide from a mixed gas containing the carbon dioxide. That is, a recovery target gas to be recovered by the gas recovery system is carbon dioxide. As shown in FIG. 1, a carbon dioxide recovery system 1 of the present embodiment includes a carbon dioxide recovery device 10, a pump 11, a flow path switching valve 12, a carbon dioxide utilizing device 13, and a controller 14.

The carbon dioxide recovery device 10 is a recovery unit that separates and recovers the carbon dioxide from the mixed gas. As the mixed gas, for example, atmospheric air or exhaust gas of an internal combustion engine can be used. The mixed gas also contains gas other than carbon dioxide. The carbon dioxide recovery device 10 is supplied with the mixed gas and discharges a carbon dioxide-removed gas obtained after the carbon dioxide is recovered from the mixed gas or the carbon dioxide recovered from the mixed gas. The configuration of the carbon dioxide recovery device 10 will be described in detail later.

The pump 11 causes the mixed gas to be supplied to the carbon dioxide recovery device 10 and causes the carbon dioxide or the carbon dioxide-removed gas to be discharged from the carbon dioxide recovery device 10. In the example shown in FIG. 1, the pump 11 is provided on the downstream side of the carbon dioxide recovery device 10 in the gas flow direction. Alternatively, the pump 11 may be provided on the upstream side of the carbon dioxide recovery device 10 in the gas flow direction.

The flow path switching valve 12 is a three-way valve that switches the flow path of the exhaust gas of the carbon dioxide recovery device 10. The flow path switching valve 12 switches the flow path of the exhaust gas to the atmosphere side to discharge the carbon dioxide-removed gas from the carbon dioxide recovery device 10, and switches the flow path of the exhaust gas to the carbon dioxide utilizing device 13 side to discharge the carbon dioxide from the carbon dioxide recovery device 10.

The carbon dioxide utilizing device 13 is a device that utilizes the carbon dioxide. The carbon dioxide utilizing device 13 may be a storage tank for storing the carbon dioxide or a conversion device for converting the carbon dioxide into fuel. As the conversion device, a device that converts the carbon dioxide into a hydrocarbon fuel such as methane can be used. The hydrocarbon fuel may be gaseous fuel at normal temperature and normal pressure, or may be liquid fuel at normal temperature and normal pressure.

The controller 14 includes a well-known microcontroller including a CPU, a ROM, a RAM and the like, and peripheral circuits thereof. The controller 14 performs various calculations and processes based on control programs stored in the ROM, and controls operations of various target devices to be controlled. The controller 14 of the present embodiment performs operation control of the carbon dioxide recovery device 10, operation control of the pump 11, flow path switching control of the flow path switching valve 12, and the like.

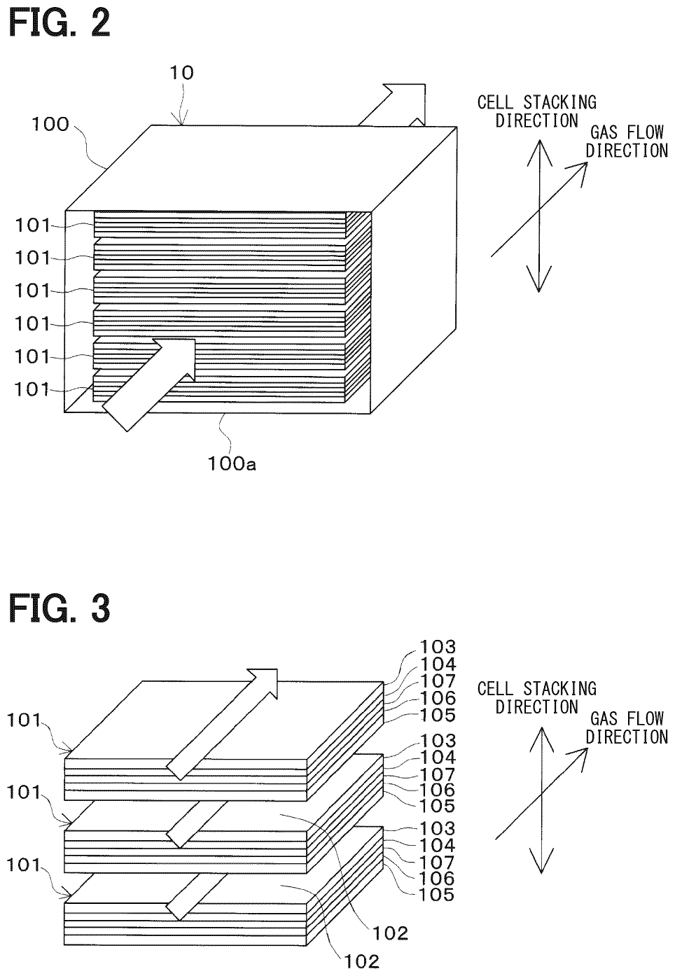

Next, the carbon dioxide recovery device 10 of the present embodiment will be described with reference to FIGS. 2 to 4. In FIGS. 2 to 4, the direction from the front side of the paper surface to the back side of the paper surface corresponds to a gas flow direction, and the vertical direction of the paper surface corresponds to a cell stacking direction.

As shown in FIG. 2, the carbon dioxide recovery device 10 includes a housing part 100. The housing part 100 is formed in a box shape and can be made of, for example, a metal material. An electrochemical cell 101 is housed in the housing part 100. The carbon dioxide recovery device 10 performs adsorption and desorption of the carbon dioxide by an electrochemical reaction of the electrochemical cell 101, and separates and recovers the carbon dioxide from the mixed gas.

The housing part 100 has two opening sections. One of the two opening sections is an introducing section 100a for introducing the mixed gas into the inside and the other is a discharge section (not shown) for discharging the carbon dioxide-removed gas or the carbon dioxide from the inside. The introducing section 100a allows the mixed gas to flow into the carbon dioxide recovery device 10 along one direction. The gas flow direction is a flow direction of the mixed gas when the mixed gas passes through the housing part 100, and corresponds to a direction from the introducing section 100a toward the discharge section of the housing part 100.

In FIG. 2, the mixed gas flows from the front side of the paper surface to the back side of the paper surface. For this reason, the front side of the housing part 100 in the drawing is the introducing section 100a, and the back side of the housing part 100 in the drawing is the discharge section. The housing part 100 may be provided with opening and closing members for opening and closing the introducing section 100a and the discharge section, respectively.

As shown in FIG. 2, a plurality of electrochemical cells 101 are arranged and stacked inside the housing part 100. The cell stacking direction in which the plurality of electrochemical cells 101 are stacked is orthogonal to the gas flow direction. Each of the electrochemical cells 101 has a plate shape, and is disposed such that the plate surface intersects the cell stacking direction.

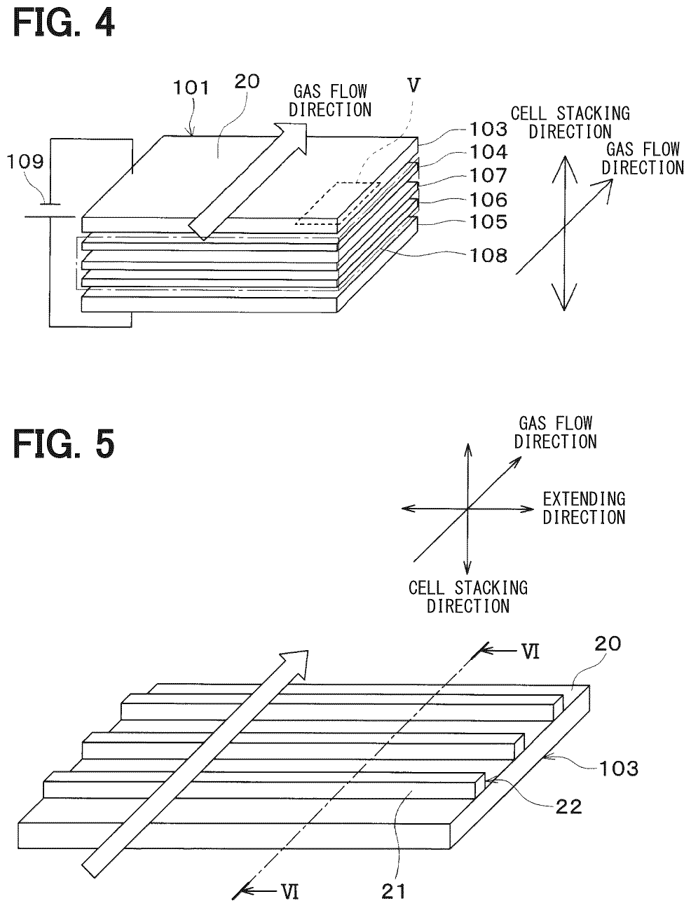

FIG. 3 shows a state in which the plurality of electrochemical cells 101 are stacked. FIG. 4 shows one electrochemical cell 101. In FIG. 4, the components of the electrochemical cell 101, such as a working electrode collector layer 103, are illustrated at intervals, but these components are actually stacked and disposed so as to be in contact with each other.

As shown in FIG. 3, a predetermined gap is provided between the adjacent electrochemical cells 101. The gap provided between the adjacent electrochemical cells 101 provides a gas flow path 102 through which the mixed gas flows.

As shown in FIGS. 3 and 4, the electrochemical cell 101 includes the working electrode collector layer 103, a working electrode 104, a counter electrode collector layer 105, a counter electrode 106, and a separator 107. Between the adjacent electrochemical cells 101, the working electrode collector layer 103 of one electrochemical cell 101 faces the counter electrode collector layer 105 of the other electrochemical cell 101 across the gas flow path 102. As shown in FIG. 4, in the electrochemical cell 101, an electrolyte 108 is provided over the working electrode 104, the counter electrode 106, and the separator 107.

Each of the working electrode collector layer 103, the working electrode 104, the counter electrode collector layer 105, the counter electrode 106, and the separator 107 has a plate shape. The electrochemical cell 101 is configured as a stacked body in which the working electrode collector layer 103, the working electrode 104, the counter electrode collector layer 105, the counter electrode 106, and the separator 107 are stacked on top of the other. The direction in which the working electrode collector layer 103 and the like are stacked in each electrochemical cell 101 is the same as the cell stacking direction in which the plurality of electrochemical cells 101 are stacked.

The working electrode collector layer 103 is made of a porous conductive material having pores through which the mixed gas containing carbon dioxide can pass. The working electrode collector layer 103 may have gas permeability and electrical conductivity, and is, for example, made of a metal material or a carbonaceous material. In the present embodiment, a metal porous body is used as the working electrode collector layer 103.

The working electrode 104 contains a carbon dioxide adsorbent, a conductive substance, and a binder. The carbon dioxide adsorbent, the conductive substance, and the binder are used in the form of a mixture.

The carbon dioxide adsorbent is configured to be capable of adsorbing carbon dioxide. The carbon dioxide adsorbent adsorbs the carbon dioxide by receiving electrons and desorbs the adsorbed carbon dioxide by releasing the electrons. As the carbon dioxide adsorbent, for example, polyanthraquinone can be used.

The conductive substance forms a conductive path to the carbon dioxide adsorbent. As the conductive substance, for example, a carbon material, such as a carbon nanotube, carbon black, or graphene, can be used.

The binder is provided in order to hold the carbon dioxide adsorbent and the conductive substance. As the binder, for example, a conductive resin can be used. As the conductive resin, for example, a fluoropolymer or an epoxy resin, which contains Ag or the like as a conductive filler, can be used. Examples of the fluoropolymer includes polytetrafluoroethylene (PTFE) and polyvinylidene fluoride (PVDF).

The counter electrode collector layer 105 is made of a conductive material. As the counter electrode collector layer 105, for example, a metal material or a carbonaceous material can be used. In the present embodiment, a metal plate is used as the counter electrode collector layer 105.

The counter electrode 106 contains an electroactive auxiliary material, a conductive material, and a binder. Since the conductive material and the binder of the counter electrode 106 have the same configuration as those of the working electrode 104, the description thereof will be omitted. In the present embodiment, the counter electrode 106 is made of a material containing an active material serving as an electron donor.

The electroactive auxiliary material of the counter electrode 106 is an auxiliary electroactive species that exchanges electrons with the carbon dioxide adsorbent of the working electrode 104. As the electroactive auxiliary material, for example, a metal complex capable of exchanging electrons by changing the valence of a metal ion can be used. Examples of such metal complex include cyclopentadienyl metal complexes such as ferrocene, nickelocene and cobaltocene, and porphyrin metal complexes. These metal complexes may be polymers or monomers.

The separator 107 is disposed between the working electrode 104 and the counter electrode 106, and separates the working electrode 104 and the counter electrode 106. The separator 107 is an insulating ion-permeable membrane that prevents physical contact between the working electrode 104 and the counter electrode 106 to suppress an electrical short circuit and allows ions to pass therethrough. As the separator 107, a cellulose film, a polymer, a composite material of a polymer and a ceramic, or the like can be used.

As the electrolyte 108, for example, an ionic liquid can be suitably used. The ionic liquid is a salt of a liquid having non-volatility under normal temperature and normal pressure.

The electrochemical cell 101 is provided with a power supply 109 connected to the working electrode collector layer 103 and the counter electrode collector layer 105. The power supply 109 can apply a predetermined voltage to the working electrode 104 and the counter electrode 106 to change the potential difference between the working electrode 104 and the counter electrode 106. The working electrode 104 is a negative electrode, and the counter electrode 106 is a positive electrode.

By changing the potential difference between the working electrode 104 and the counter electrode 106, the electrochemical cell 101 can be switched between a carbon dioxide recovery mode in which the carbon dioxide is recovered at the working electrode 104 and a carbon dioxide release mode in which the carbon dioxide is released from the working electrode 104, and operated in the carbon dioxide recovery more or the carbon dioxide release mode. The carbon dioxide recovery mode is a charging mode in which the electrochemical cell 101 is charged, and the carbon dioxide release mode is a discharging mode in which the electrochemical cell 101 is discharged.

In the carbon dioxide recovery mode, a first voltage V1 is applied between the working electrode 104 and the counter electrode 106, and electrons are supplied from the counter electrode 106 to the working electrode 104. At the first voltage V1, the working electrode potential is lower than the counter electrode potential. The first voltage V1 may fall within a range from 0.5 to 2.0 V. In the carbon dioxide recovery mode, since the electrons are supplied from the counter electrode 106 to the working electrode 104, the carbon dioxide adsorbent is bonded to carbon dioxide according to the electrons being supplied.

In the carbon dioxide release mode, a second voltage V2 is applied between the working electrode 104 and the counter electrode 106, and electrons are supplied from the working electrode 104 to the counter electrode 106. The second voltage V2 is different from the first voltage V1. The second voltage V2 is a voltage lower than the first voltage V1, and a magnitude relationship between the working electrode potential and the counter electrode potential is not limited. That is, in the carbon dioxide release mode, the working electrode potential may be lower than the counter electrode potential, the working electrode potential may be equal to the counter electrode potential, or the working electrode potential may be higher than the counter electrode potential.

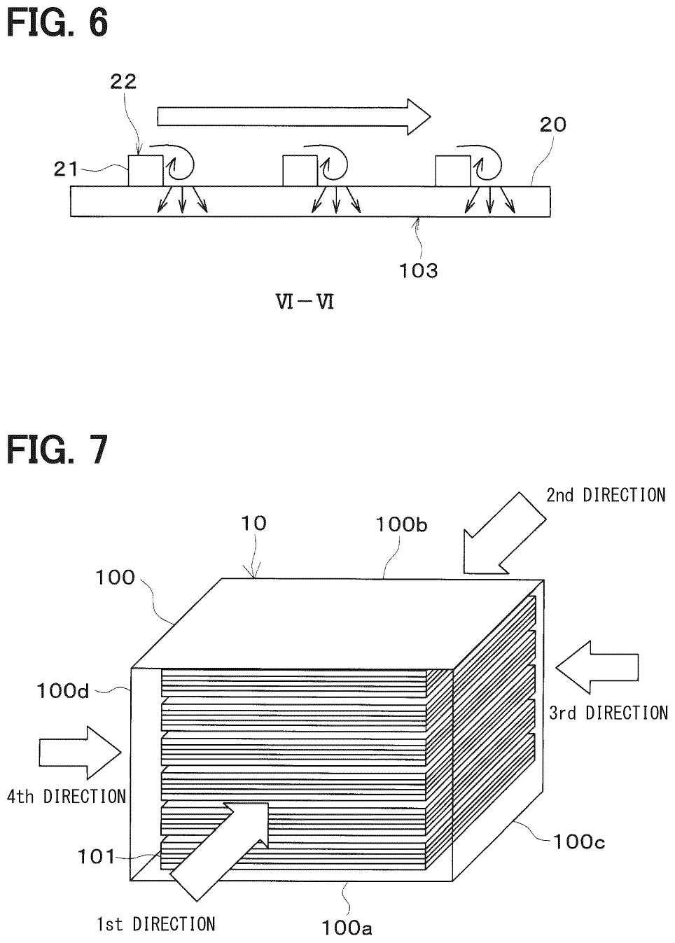

As shown in FIGS. 5 and 6, the surface of the working electrode collector layer 103 is configured as a contact surface 20 that comes in contact with the mixed gas. A protrusion 22 is provided on the contact surface 20 to protrude from the contact surface 20. The protrusion 22 has a wall surface 21 facing in the gas flow direction. Therefore, the protrusion 22 serves as a wall surface forming part that forms the wall surface 21.

The wall surface 21 facing in the gas flow direction means that the wall surface 21 is not parallel to the gas flow direction. That is, the wall surface 21 is provided so as to intersect the gas flow direction. In the present embodiment, the wall surface 21 is provided so as to be orthogonal to the gas flow direction.

The protrusion 22 is formed in a shape extending perpendicularly to the flow direction of the mixed gas introduced from the introducing section 100a. In the present embodiment, the protrusion 22 is formed in a quadrangular prism shape extending in a direction (hereinafter, referred to as an extending direction) orthogonal to both the gas flow direction and the cell stacking direction. A plurality of the protrusions 22 are arranged side by side in the gas flow direction.

As described above, in the carbon dioxide recovery system 1 of the present embodiment, the protrusions 22 each having the wall surface 21 facing in the gas flow direction are provided on the surface of the working electrode collector layer 103 of the electrochemical cell 101. According to this, it is possible to form a vortex due to separation of the main flow of the mixed gas on a downstream side of the protrusion 22 in the gas flow direction. As a result, the diffusion of the mixed gas can be promoted on the contact surface 20 that comes in contact with the mixed gas, and thus the adsorption performance of the carbon dioxide can be improved.

In the present embodiment, the protrusion 22 is formed in the shape extending perpendicularly to the flow direction of the mixed gas introduced from the introducing section 100a. According to this, since the diffusion of the mixed gas can be further promoted, the adsorption performance of the carbon dioxide can be further improved.

### Second Embodiment

Next, a second embodiment of the present disclosure will be described with reference to FIGS. 7 to 9. In the present embodiment, the arrangement of the protrusions 22 is changed from that in the first embodiment.

As shown in FIG. 7, in the carbon dioxide recovery system 1 of the present embodiment, the carbon dioxide recovery device 10 includes a first introducing section 100a, a second introducing section 100b, a third introducing section 100c, and a fourth introducing section 100d for introducing the mixed gas into the housing part 100.

The first introducing section 100a introduces the mixed gas into the housing part 100 of the carbon dioxide recovery device 10 in a first direction. The second introducing section 100b introduces the mixed gas into the housing part 100 in a second direction. The third introducing section 100c introduces the mixed gas into the housing part 100 in a third direction. The fourth introducing section 100d introduces the mixed gas into the housing part 100 in a fourth direction.

The first to fourth directions are different from each other. Each of the first to fourth directions is a direction orthogonal to the cell stacking direction. In the present embodiment, the second direction is a direction opposing to the first direction. The third direction and the fourth direction are directions orthogonal to each of the first direction and the second direction. The third direction is a direction opposing to the fourth direction.

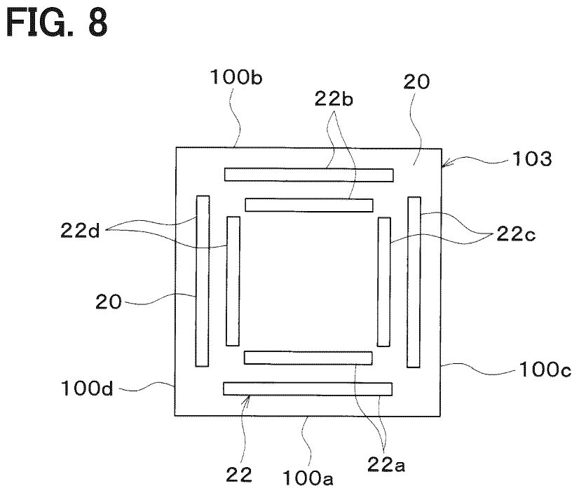

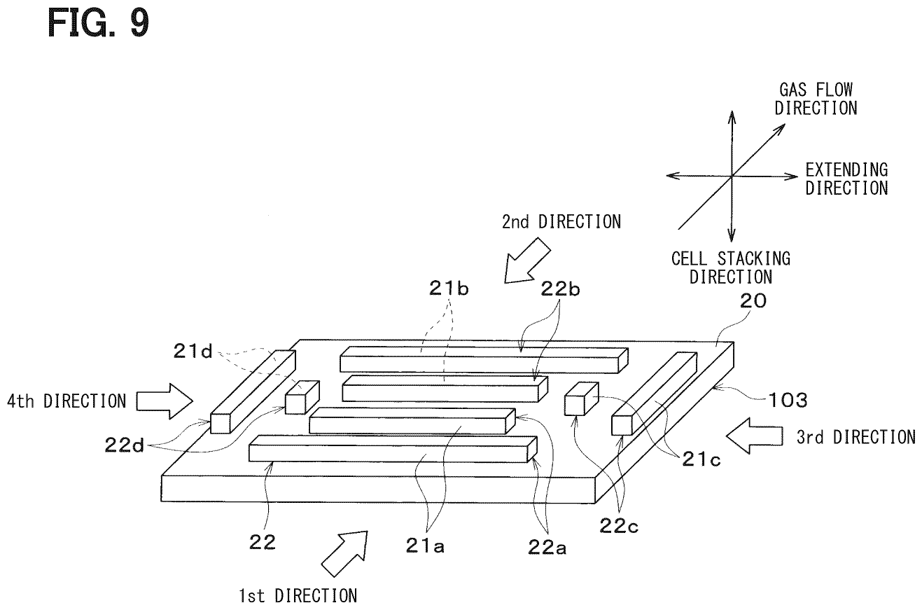

As shown in FIGS. 8 and 9, in the present embodiment, a first protrusion 22a, a second protrusion 22b, a third protrusion 22c, and a fourth protrusion 22d are provided as the protrusions 22. The first protrusion 22a corresponds to a first wall surface forming part, and the second protrusion 22b corresponds to a second wall surface forming part.

The first protrusion 22a is formed in a shape extending perpendicularly to the first direction. The wall surface 21 of the first protrusion 22a (hereinafter, referred to as a first wall surface 21a) is provided so as to come in contact with the mixed gas introduced from the first introducing section 100a. In the present embodiment, the first wall surface 21a is provided so as to be orthogonal to the first direction. A plurality of the first protrusions 22a are arranged in the first direction.

The second protrusion 22b is formed in a shape extending perpendicularly to the second direction. The wall surface 21 of the second protrusion 22b (hereinafter, referred to as a second wall surface 21b) is provided so as to come in contact with the mixed gas introduced from the second introducing section 100b. In the present embodiment, the second wall surface 21b is provided so as to be orthogonal to the second direction. A plurality of the second protrusions 22b are arranged in the second direction.

The third protrusion 22c is formed in a shape extending perpendicularly to the third direction. The wall surface 21 of the third protrusion 22c (hereinafter referred to as a third wall surface 21c) is provided so as to come in contact with the mixed gas introduced from the third introducing section 100c. In the present embodiment, the third wall surface 21c is provided so as to be orthogonal to the third direction. A plurality of the third protrusions 22c are arranged in the third direction.

The fourth protrusion 22d is formed in a shape extending perpendicularly to the fourth direction. The wall surface 21 of the fourth protrusion 22d (hereinafter referred to as a fourth wall surface 21d) is provided so as to come in contact with the mixed gas introduced from the fourth introducing section 100d. In the present embodiment, the fourth wall surface 21d is provided so as to be orthogonal to the fourth direction. A plurality of the fourth protrusions 22d are arranged in the fourth direction.

As described above, the carbon dioxide recovery system 1 of the present embodiment includes the first to fourth protrusions 22a to 22d as the protrusions 22. Each of the protrusions 22a to 22d is formed in the shape extending perpendicularly to each corresponding direction of the first to fourth directions. According to this, for each of the mixed gases introduced in the first to fourth introducing sections 100a to 100d, the diffusion of the mixed gases can be promoted by the first to fourth protrusions 22a to 22d, respectively. Therefore, also in the carbon dioxide recovery system 1 into which the mixed gas is introduced from the plurality of introducing sections 100a to 100d, the adsorption performance of the carbon dioxide can be reliably improved.

### Third Embodiment

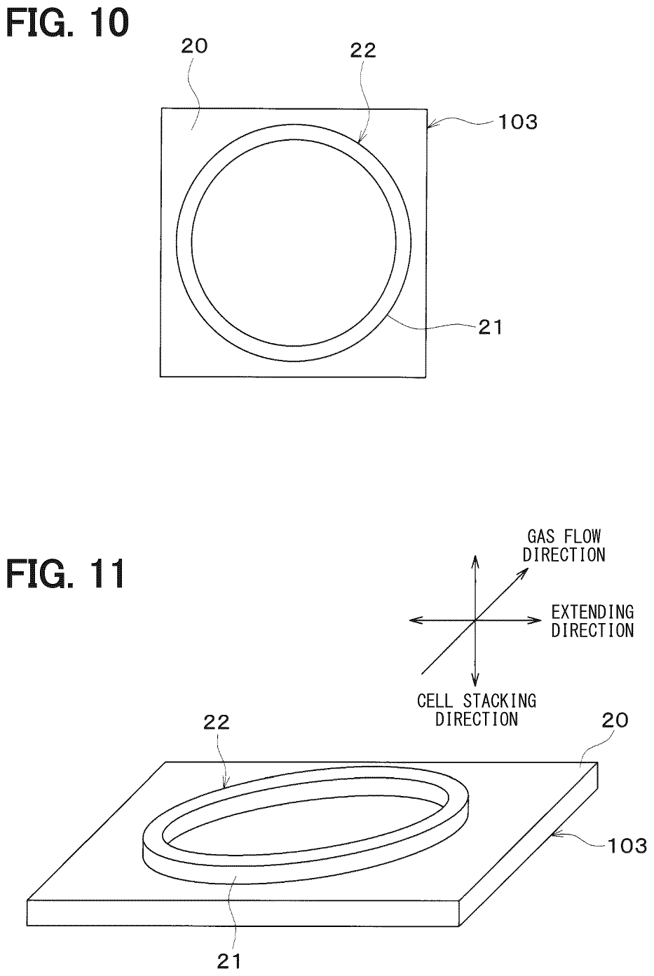

Next, a third embodiment of the present disclosure will be described with reference to FIGS. 10 and 11. In the present embodiment, the shape of the protrusion 22 is changed from that of the first embodiment.

As shown in FIGS. 10 and 11, in the carbon dioxide recovery system 1 of the present embodiment, the protrusion 22 has a circular shape when viewed in the cell stacking direction. Therefore, the wall surface 21 of the protrusion 22 has a curved surface. By providing such a protrusion 22, it is possible to reliably improve the adsorption performance of the carbon dioxide also in the carbon dioxide recovery system 1 into which the mixed gas is introduced from any directions.

### Fourth Embodiment

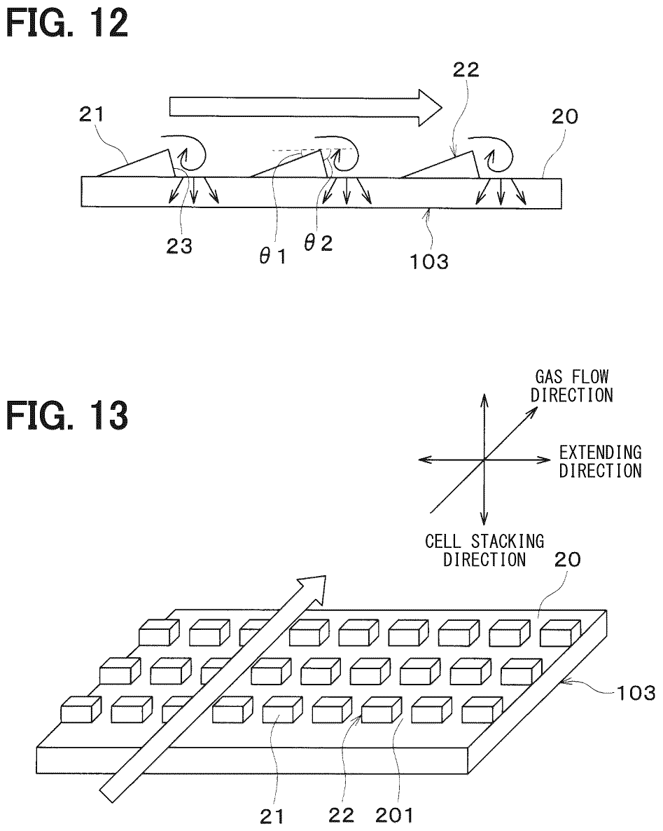

Next, a fourth embodiment of the present disclosure will be described with reference to FIG. 12. In the present embodiment, the shape of the protrusion 22 is changed from that of the first embodiment.

As shown in FIG. 12, in the carbon dioxide recovery system 1 of the present embodiment, the protrusion 22 is formed in a triangular prism shape extending in the extending direction. The protrusion 22 has a wall surface 21 and a downstream surface 23 disposed downstream of the wall surface 21 in the gas flow direction. An angle θ1 defined between the wall surface 21 and the gas flow direction is smaller than an angle θ2 defined between the downstream surface 23 and the gas flow direction.

According to the carbon dioxide recovery system of the present embodiment, the pressure loss of the mixed gas flow can be reduced by reducing the angle θ1 between the wall surface 21 and the gas flow direction. As a result, a decrease in energy efficiency of the pump 11 can be suppressed. Further, by increasing the angle θ2 between the downstream surface 23 and the gas flow direction, the gas flow toward the contact surface 20 can be secured. As a result, the adsorption performance of the carbon dioxide can be improved.

### Fifth Embodiment

Next, a fifth embodiment of the present disclosure will be described with reference to FIG. 13. In the present embodiment, the shape of the protrusion 22 is changed from that of the first embodiment.

As shown in FIG. 13, in the carbon dioxide recovery system 1 of the present embodiment, a plurality of protrusions 22 are provided on the contact surface 20. The plurality of protrusions 22 are arranged side by side in each of the gas flow direction and the extending direction.

The contact surface 20 is provided with the protrusions 22 and planar portions 201 on which the protrusions 22 are not provided. The protrusions 22 and the planar portions 201 are alternately arranged in the extending direction. The planar portion 201 forms a gap (that is, a gas flow path) through which the mixed gas flows.

According to the carbon dioxide recovery system of the present example embodiment, since there is a place where the planar portion 201 is disposed in the flow direction of the mixed gas, the pressure loss of the mixed gas flow can be reduced. On the other hand, the protrusions 22 can promote the diffusion of the mixed gas. Therefore, the adsorption performance of the carbon dioxide can be improved while reducing the pressure loss of the mixed gas flow.

### Sixth Embodiment

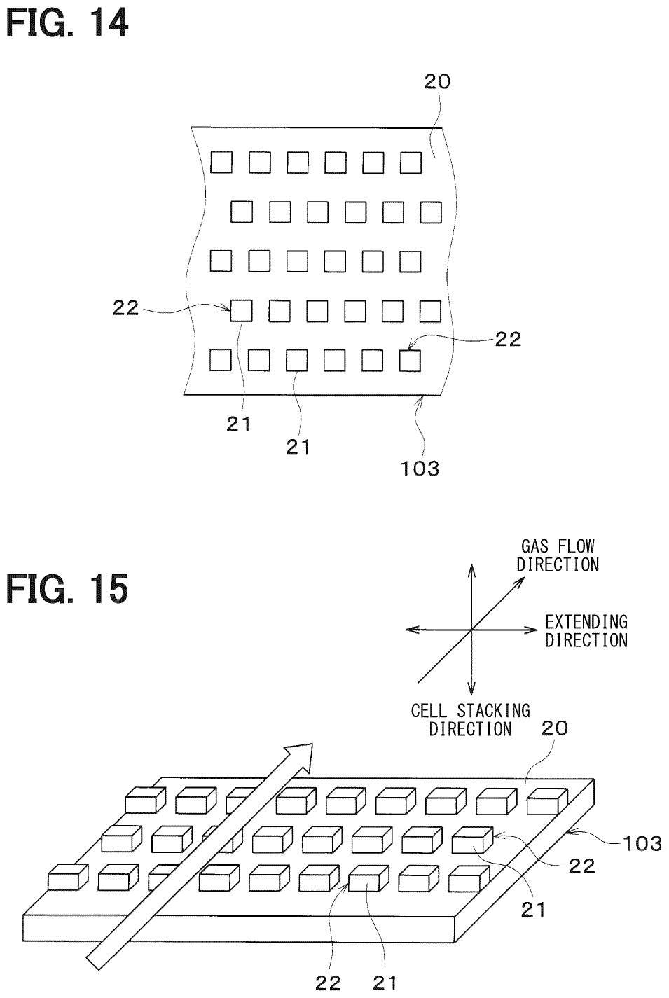

Next, a sixth embodiment of the present disclosure will be described with reference to FIGS. 14 and 15. In the present embodiment, the arrangement of the protrusions 22 is changed from that in the fifth embodiment.

As shown in FIGS. 14 and 15, in the carbon dioxide recovery system 1 of the present embodiment, the plurality of protrusions 22 are arranged in a staggered manner. According to this, it is possible to eliminate the flow of the mixed gas linearly passing through the protrusions 22, and thus it is possible to obtain the diffusion effect of the mixed gas more reliably by the protrusions 22.

The present disclosure is not limited to the embodiments described above, and various modifications can be made as follows in a range without departing from the spirit of the present disclosure.

(1) In the embodiments described above, the example in which the gas recovery system of the present disclosure is applied to the carbon dioxide recovery system 1 that recovers the carbon dioxide from the mixed gas has been described, but the present disclosure is not limited to this example. The gas recovery system of the present disclosure may be applied to a configuration in which a specific type of gas other than the carbon dioxide is recovered from a mixed gas.

(2) In the first to third, fifth, and sixth embodiments described above, the examples in which the wall surface 21 of the protrusion 22 is provided so as to be orthogonal to the gas flow direction have been described, but the wall surface 21 may not necessarily be orthogonal to the gas flow direction.

(3) In the embodiments described above, the example in which the protrusions 22 are provided on the surface of the working electrode collector layer 103 has been described. However, the positions where the protrusions 22 are provided are not limited to this example. For example, the protrusions 22 may be provided on the surface of the counter electrode collector layer 105.

(4) In the embodiments described above, the example in which the protrusion 22 protruding from the contact surface 20 is employed as the wall surface forming part has been described, but the wall surface forming part is not limited to this example. For example, a recess formed by recessing a part of the contact surface 20 may be employed as the wall surface forming part, and the wall surface 21 may be provided by the recess.

(5) In the second embodiment described above, the example has been described in which the first to fourth introducing sections 100a to 100d for introducing the mixed gas into the housing part 100 in the first to fourth directions are provided, and the first to fourth protrusions 22a to 22d each formed in the shape extending perpendicularly to the corresponding direction of the first to fourth directions are provided. However, the configurations of the introducing sections 100a to 100d and the protrusions 22a to 22d are not limited to this example.

For example, the housing part 100 may be provided with the first and second introducing sections 100a and 100b for introducing the mixed gas into the housing part 100 in the first and second directions, and the first and second protrusions 22a and 22b each formed in a shape extending perpendicularly to the corresponding direction of the first and second directions may be provided. Further, the housing part 100 may be provided with the first to third introducing sections 100a to 100c for introducing the mixed gas into the housing part 100 in the first to third directions, and the first to third protrusions 22a to 22c each formed in a shape extending perpendicularly to the corresponding direction of the first to third directions may be provided. Furthermore, the housing part 100 may be provided with the first to N-th (N is an integer of 5 or more) introducing sections for introducing the mixed gas into the housing part 100 in the first to N-th directions, and first to N-th protrusions each formed in a shape extending perpendicularly to the corresponding direction of the first to N-th directions may be provided.

Although the present disclosure has been described in accordance with the embodiments, it is understood that the disclosure is not limited to such embodiments and structures. The present disclosure encompasses various modifications and variations within the scope of equivalents. In addition, while the various elements are shown in various combinations and configurations, which are exemplary, other combinations and configurations, including more, less or only a single element, are also within the spirit and scope of the present disclosure.

What is claimed is:

1. A gas recovery system that recovers a recovery target gas to be recovered from a mixed gas containing the recovery target gas by an electrochemical reaction, the gas recovery system comprising:
a recovery unit into which the mixed gas is introduced;
an electrochemical cell disposed in the recovery unit, the electrochemical cell having a working electrode containing an adsorbent capable of adsorbing the recovery target gas and a counter electrode, wherein
when a voltage is applied between the working electrode and the counter electrode, electrons are supplied from the counter electrode to the working electrode, and the adsorbent bonds with the recovery target gas according to the electrons being supplied,
the electrochemical cell is disposed so as to come in contact with the recovery target gas,
the electrochemical cell has a wall surface forming part on a contact surface with which the recovery target gas comes in contact, and
the wall surface forming part has a wall surface that faces in a flow direction of the recovery target gas.

2. The gas recovery system according to claim 1, wherein
the recovery unit has an introducing section that introduces the mixed gas into the recovery unit in one direction, and
the wall surface forming part has a shape extending perpendicularly to a flow direction of the mixed gas introduced from the introducing section.

3. The gas recovery system according to claim 1, wherein
the recovery unit has:
a first introducing section that introduces the mixed gas into the recovery unit in a first direction; and
a second introducing section that introduces the mixed gas into the recovery unit in a second direction different from the first direction,
the wall surface forming part includes:
a first wall surface forming part that has a shape extending perpendicularly to the first direction; and
a second wall surface forming part that has a shape extending perpendicularly to the second direction,
the wall surface of the first wall surface forming part is provided so as to come in contact with the mixed gas introduced from the first introducing section, and
the wall surface of the second wall surface forming part is provided so as to come in contact with the mixed gas introduced from the second introducing section.

4. The gas recovery system according to claim 1, wherein
the wall surface includes a curved surface.

5. The gas recovery system according to claim 1, wherein
the wall surface forming part has the wall surface and a downstream surface disposed downstream of the wall surface in a flow direction of the mixed gas, and
an angle defined between the wall surface and the flow direction of the mixed gas is smaller than an angle defined between the downstream surface and the flow direction of the mixed gas.

6. The gas recovery system according to claim 1, wherein
the contact surface is provided with the wall surface forming part and a planar portion where the wall surface forming part is not provided.

7. The gas recovery system according to claim 1, wherein
the contact surface is provided with a plurality of the wall surface forming parts, and
the plurality of the wall surface forming parts are arranged in a staggered manner.

8. The gas recovery system according to claim 1, wherein
the recovery target gas is carbon dioxide.
